(19) United States
(12) Patent Application Publication
(10) Pub. No.: US 2021/0401213 A1
(43) Pub. Date: Dec. 30, 2021

(54) DRIVE DEVICE FOR ELECTRIC CURTAIN

(71) Applicant: NINGBO SUNFREE MOTOR TECHNOLOGY COMPANY LIMITED, NINGBO (CN)

(72) Inventors: Liang WANG, NINGBO (CN); Jianhong WEI, NINGBO (CN)

(21) Appl. No.: 17/359,584

(22) Filed: Jun. 27, 2021

(30) Foreign Application Priority Data
Jun. 28, 2020 (CN) 202010598230.8

(51) Int. Cl. A47H 5/02; H02K 5/08; H02K 5/24; H02K 11/33

(52) U.S. Cl. CPC A47H 5/02; H02K 5/08; H02K 2211/03; H02K 11/33; H02K 5/24

(57) ABSTRACT

A drive device for an electric curtain is provided which comprises an integrally-formed plastic housing and a drawer frame which is disposed in the plastic housing; a drive motor and a control board are mounted on the drawer frame; in the drive device of the present invention, the integrally-formed plastic housing replaces the existing aluminum profile to solve the safety problems of short circuiting, electric conduction and firing due to aluminum scraps left in the housing; such that the entire external structure of the drive device has no section difference and color difference, and there is no broken joint formed at the connection with the plastic end cover, satisfying the market requirements. Furthermore, in the drive device, the drawer frame is slidably disposed in the plastic housing and the drive motor and the control board are supported on the drawer frame, facilitating device assembly and production efficiency.

### CROSS-REFERENCE TO RELATED APPLICATIONS

This application claims priority to Chinese Patent Application No. 202010598230.8 with a filing date of Jun. 28, 2020. The content of the aforementioned application, including any intervening amendments thereto, are incorporated herein by reference.

### TECHNICAL FIELD

The present invention relates to the field of electric curtain technologies, and in particular to a drive device for an electric curtain.

### BACKGROUND

Along with continuous improvement of people's lives and the popularization of electric curtains, people have higher and higher requirements for safety, performance and external aesthetics for electric curtains. A drive device for an electric curtain on the market at present mainly comprises a housing, a motor, a clutch mechanism, a speed reducer, a control board, and a power source and the like. The housing of the drive device usually comprises an upper plastic end cover, an aluminum alloy profile, and a plastic lower end cover. During a processing and cutting process of the aluminum alloy profile, a large amount of aluminum scraps will be left on an inner wall of the aluminum alloy profile. The power source of the drive device usually is a switching power source which is externally connected with strong current. During use, the residual aluminum scraps will bring failures to the switching power source and control board, such as poor reception of signals of the control board, short-circuited fire of elements and devices, and electric conduction of the aluminum profile and the like, resulting in many after-sales problems and potential safety hazards.

Furthermore, in an actual production process, processing accuracies of the plastic covers and the aluminum profile differ greatly. When the plastic covers are connected to both ends of the aluminum profile, there will be a difference among a front section (the upper plastic end cover), a middle section (the aluminum alloy profile) and a rear section (the lower plastic end cover) as well as section joints at their connections. Further, the aluminum profile is vertically cut. Therefore, when there are section differences among sections and protrusions at the cut of the aluminum alloy on the housing, there will be a risk of scratching a user during production and storage. At the same time, because of inconsistent materials of the housing, a color difference is easily generated and will be highlighted after a time of use, bringing poor external aesthetics.

### SUMMARY

The object of the present invention is to provide a drive device for an electric curtain to solve the problems of safety and poor entire aesthetics existing in the drive devices in the prior art.

In order to achieve the above object, the present invention provides a drive device for an electric curtain. The drive device comprises:

an integrally-formed plastic housing, and a plastic end cover is disposed at least one end of the plastic housing, and an outer end face of the plastic end cover is flushed with an end face of the plastic housing or recessed in the plastic housing; and

a drawer frame, and the drawer frame is disposed in the plastic housing, a drive motor and a control board are mounted on the drawer frame, and the drive motor is in electrical connection with the control board.

Compared with the prior art, the present invention has the following beneficial effects: in the drive device of the present invention, the integrally-formed plastic housing replaces the existing aluminum profile to solve the safety problems of short circuiting, electric conduction and firing due to aluminum scraps left in the housing; the outer end face of the plastic end cover is flushed with the end face of the plastic housing or recessed in the plastic housing, such that the entire external structure of the drive device has no section difference and color difference, and there is no broken joint formed at the connection with the plastic end cover, satisfying the market requirements. Furthermore, in the drive device, the drawer frame is slidably disposed in the plastic housing and the drive motor and the control board are supported on the drawer frame, facilitating device assembly and production efficiency.

Preferably, an end of the drawer frame is flushed with an end face of the plastic housing to form an end cover, and the other end of the drawer frame is protruded into the plastic housing and fixedly connected with the interior of the plastic housing. The end cover of the drawer frame is flushed with the plastic housing such that the entire plastic housing has no section difference and color difference, and there is no broken joint formed at the connection of the end cover and the plastic housing.

Preferably, a locating portion fixedly connected with an end of the drawer frame is integrally formed in the plastic housing, and a connection window is opened on the locating portion.

Preferably, a movement controlling module is inserted on the drawer frame. The movement controlling module is inserted into the connection window and series-connected with the control board. The movement controlling module is inserted into the connection window and series-connected with the control board such that the movement controlling module can be changed easily.

Preferably, connection holes are disposed along a circumferential direction of the locating portion, mounting hole columns mated with the connection holes are disposed at the end of the drawer frame, and the end of the drawer frame is fixedly connected with the locating portion by inserting the screws into the connection holes and the mounting hole columns.

Preferably, a fitting pin is convexly disposed at a side of the plastic end cover facing toward the plastic housing, and a fitting groove mated with the fitting pin is disposed on the locating portion. The plastic end cover is detachably connected with the locating portion through the fitting pin and the fitting groove.

Preferably, the drawer frame comprises a front frame body, a middle frame body and a rear frame body.

The drive motor is supported on the front frame body, and a vibration damping bushing is sleeved on the drive motor to avoid generating noise between the drive motor and the drawer frame during the operation of the drive motor, thus increasing the use performance of the drive device.

An isolation plate is integrally formed on the middle frame body along a length direction of the entire middle frame body, and the isolation plate is disposed perpendicular to the middle frame body. Further, limiting pieces opposed to the end faces of both sides of the isolation plate are integrally formed on the middle frame body. The control board is fixed at a side surface of the isolation plate through the limiting piece, and a limiting block is disposed at a side of the isolation plate and the control board is disposed and at an end of the isolation plate close to the front frame body. A switching power source board is disposed at the other side surface of the isolation plate, the switching power source board is fixed on the side surface of the isolation plate through the limiting piece, and limiting plates are disposed integrally and convexly at both ends of the side surface of the isolation plate and the switching power source board is disposed. By separately disposing the control board and a transformer using the isolation plate, interference generated by strong and weak currents can be prevented from affecting the service lives of other electric elements. At the same time, in order to enable the drive device to adapt to the vibration generated by the drive motor, the control board and the switching power source board are fixed using the limiting piece and the limiting block and the like to increase the operational stability of the drive device.

A mounting chamber is enclosed integrally with the limiting plate as an end on the rear frame body. The movement controlling module is inserted in the mounting chamber. An abutting window is opened at a side surface of the mounting chamber corresponding to the control board, and the movement controlling module is series-connected with the control board through the abutting window. At least one limiting column for winding and bending a power line is disposed integrally on an outer side surface of the mounting chamber corresponding to the switching power source board. The movement controlling module is inserted into the mounting chamber through the connection window such that an end of the movement controlling module is connected in series to the control board through the abutting window. Thus, the mounting chamber achieves the effect of locating the movement controlling module and the change of the movement controlling module is facilitated at the same time. Furthermore, the bending of the power line interrupts an external pulling force along a direction of the power line, thus increasing the tensile strength of the power line, and avoiding loosening of a welding point of the power line resulting from directly transmitting the external pulling force to a welding point between the power line and the switching power source board in the device.

Preferably, limiting sheets are uniformly distributed on inner side surfaces of the front frame body and the middle frame body. Isolation strips are uniformly distributed at a side surface of the isolation plate corresponding to the control board. A guiding strip convexly and integrally disposed in the mounting chamber, and the guiding strip corresponding to an opening of the mounting chamber is shaped like round chamfer. Furthermore, an electric control element is further disposed at an outer side of the mounting chamber corresponding to the control board, and the electric control element is in electrical connection with the control board. The limiting sheets and the isolation strips in the drawer frame may assist the drive motor and the control board to adapt to the vibration generated by the drive motor during operation.

Preferably, a control valve in connection with the electric control element is disposed at a position of the locating portion corresponding to the electric control element. Further, the control valve is exposed on the plastic end cover. Further, the opening of the mounting chamber and the connection window of the locating portion are correspondingly disposed.

Preferably, a communication guide connector is exposed and disposed at an end of the movement controlling module corresponding to the control board, and a corresponding abutting connector is disposed on the control board and protrudes through the abutting window into the mounting chamber. When the movement controlling module is inserted into the mounting chamber, the communication guide connector and the abutting connector are connected. When the movement controlling module is to be changed, the movement controlling module is pulled out of the mounting chamber to separate the communication guide connector of the movement controlling module from the abutting connector of the control board. Thus, the operation is simple.

### BRIEF DESCRIPTION OF THE DRAWINGS

FIG. 1 is a structural schematic diagram of the present invention.

FIG. 2 is an assembling diagram of a drawer frame according to the present invention.

FIG. 3 is an exploded view of the present invention.

FIG. 4 is a structural schematic diagram of a drawer frame according to the present invention.

In the drawings, reference numerals are described as follows: 1. plastic housing, 2. plastic end cover, 2-1. fitting pin, 3. drawer frame, 3-1. front frame body, 3-2. middle frame body, 3-3. rear frame body, 4. drive motor, 5. control board, 5-1. abutting connector, 6. end cover, 7. locating portion, 7-1. connection window, 7-2. connection hole, 7-3. fitting groove, 8. movement controlling module, 8-1. communication guide connector, 9. mounting hole column, 10. vibration damping bushing, 11. isolation plate, 11-1. limiting block, 11-2. limiting plate, 11-3. isolation strip, 12. limiting piece, 13. switching power source board, 14. mounting chamber, 14-1. abutting window, 14-2. limiting column, 15. limiting sheet, 16. electric control element, 17. control valve.

### EMBODIMENTS

The present invention will be further described below in combination with the specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly comprise at least one feature. In the descriptions of the present invention, “several” has at least two meanings, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

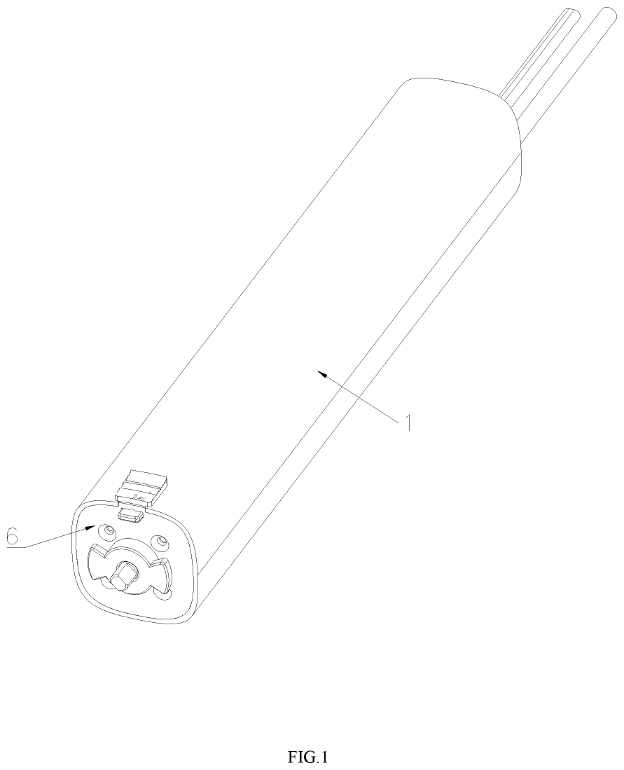

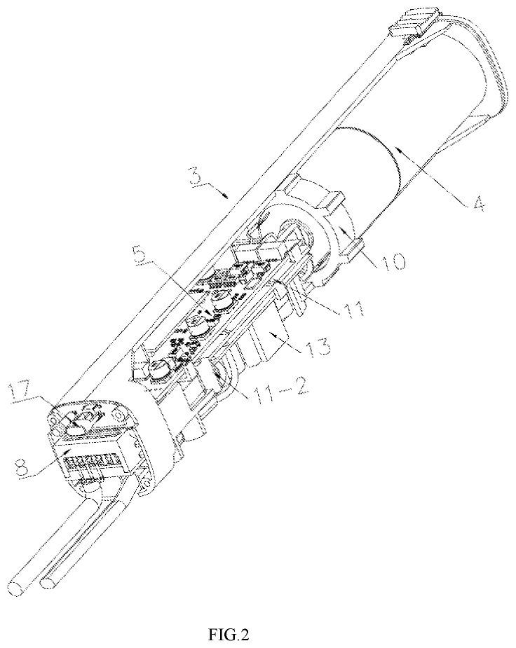

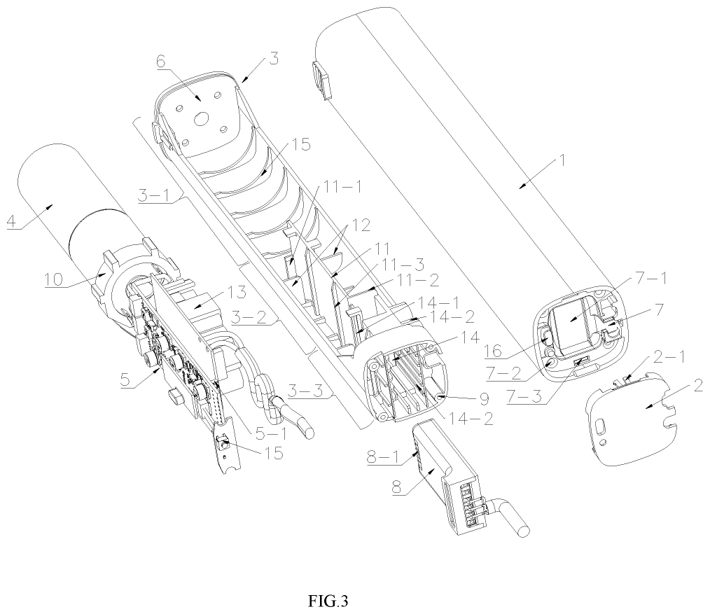

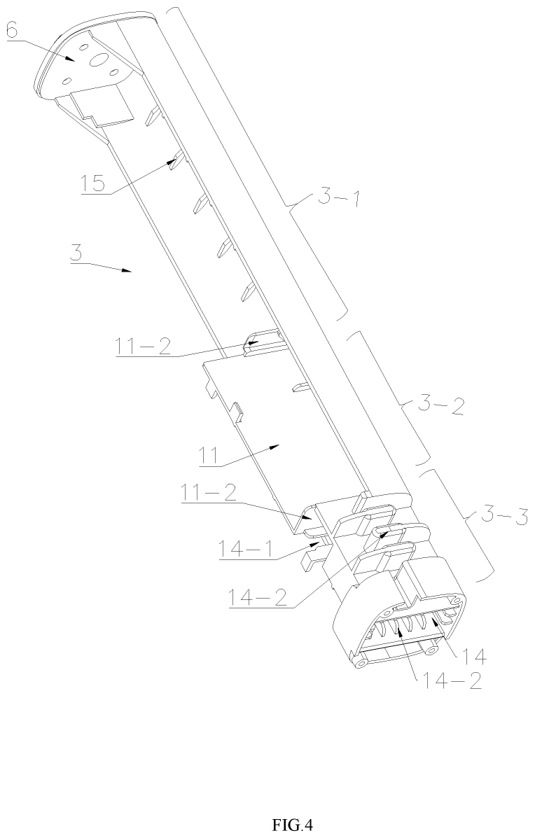

As shown in FIGS. 1-4, the present invention provides the following technical solution. There is provided a drive device for an electric curtain, comprising an integrally-formed plastic housing 1 and a drawer frame 3.

A plastic end cover 2 is disposed at least one end of the plastic housing 1. The plastic housing 1 and the plastic end cover 2 both are made of a flame-retarded material to prevent occurrence of fire. Further, the plastic housing 1 is a hollow structure with both ends penetrated through. An outer end face of the plastic end cover 2 is flushed with the plastic housing 1 or recessed in the plastic housing 1. In this embodiment, an end of the plastic housing 1 is provided with the plastic end cover 2, and an outer end face of the plastic end cover 2 is flushed with an end face of the plastic housing 1, and at the same time, a locating portion 7 is integrally disposed at an end of the plastic housing 1 corresponding to the plastic end cover 2.

The drawer frame 3 is disposed in the plastic housing 1. The drawer frame is made of a flame-retarded material to prevent occurrence of fire. One end of the drawer frame 3 is protruded into the plastic housing 1 and fixedly connected with the locating portion 7, and the other end of the drawer frame 3 extends to the other end of the plastic housing 1 to integrally form an end cover 6. The end cover 6 is also flushed with an end face of the plastic housing 1. In this case, the entire external appearance of the drive device does not have section difference and color difference, and at the same time, there will be no broken joint formed at the connections of the drawer frame 3, the plastic end cover 2 and the plastic housing 1. Furthermore, a drive motor 4, a control board 5 integrated with a control circuit of the drive motor 4, a switching power source board 13 for transforming voltage, and a movement controlling module 8 integrating a controlling module of one or more motor control modes are disposed on the drawer frame 3. By disposing above these components on the drawer frame 3, the internal structure of the plastic housing 1 will be simplified, fewer limiting structures are disposed, and integral formation, production and assembly are facilitated. At the same time, the disposal of the drawer frame 3 also facilitates repair and change of the components in the drive device. More importantly, in this drive device, the controlling module of motor control mode is separated from a motor drive circuit. Thus, a user may integrate one or more motor control modes into the movement controlling module 8 according to actual requirements, and then insert the movement controlling module 8 into a different drive device for an electric curtain, thereby solving the problem of resource wastes and greatly reducing product costs.

In the present invention, the original aluminum profile is replaced with the plastic housing 1, which solves the potential safety hazards such as short-circuiting, electric conduction and firing due to a large amount of aluminum scraps left in the housing 1 and reduces the after-sales problems. Furthermore, the plastic housing 1 is integrally formed so that the entire structure has no section difference and color difference, coupled with the plastic end cover 2 embedded on an end of the plastic housing 1. Further, there is no broken joint at the connection with the plastic end cover 2, presenting simple structure and clean external appearance and meeting the market demands. Furthermore, the plastic housing 1 will not shield signals and thus more suitable for the electric curtain to receive signals.

The drawer frame 3 comprises a front frame body 3-1, a middle frame body 3-2 and a rear frame body 3-3 in sequence from the end cover 6 to the plastic end cover 2.

The drive motor 4 is supported on the front frame body 3-1. The drive motor 4 further integrates a speed reducer and a clutch mechanism. A vibration damping bushing 10 is further sleeved on the drive motor 4, so as to reduce vibration generated by the drive motor 4 during operation, thus avoiding affecting the operation stability of the drive device.

The control board 5 and the switching power source board 13 are disposed on the middle frame body 3-2. The middle frame body 3-2 is mainly used to isolate the interferences of strong and weak currents of the control board 5 and the switching power source board 13. For this purpose, an isolation plate 11 perpendicular to the middle frame body 3-2 is disposed along a length direction of the entire middle frame body 3-2 on the middle frame body 3-2. The control board 5 and the switching power source board 13 are disposed at both side surfaces of the isolation plate 11 respectively. Specifically, limiting pieces 12 opposed to the end faces of both sides of the isolation plate 11 are integrally formed on the middle frame body 3-2, the control board 5 is fixed at a side surface of the isolation plate 11 through the limiting piece 12, and a limiting block 11-1 is disposed at a side of the isolation plate 11 where the control board 5 is disposed and at an end close to the front frame body 3-1; the switching power source board 13 is disposed at the other side surface of the isolation plate 11, the switching power source board 13 is fixed on the side surface of the isolation plate 11 through the limiting piece 12, and limiting plates 11-2 are integrally and convexly disposed at both ends of the side surface of the isolation plate 11 where the switching power source board 13 is disposed. Isolation strips 11-3 are uniformly distributed at a side surface of the isolation plate 11 corresponding to the control board 5. The limiting pieces 12, the limiting block 11-1 and the isolation strips 11-3 can assist the isolation plate 11 to stably fix the control board 5 and the switching power source board 13 at both side surfaces of the isolation plate 11 and also assist the control board 5 and the switching power source board 13 to adapt to the vibration generated by the drive motor 4 during operation, thus increasing the operation stability of the drive device.

Limiting sheets 15 are uniformly distributed on inner side surfaces of the front frame body 3-1 and the middle frame body 3-2. The limiting sheets 15 on the drawer frame 3 can assist the drive motor 4 and the control board 5 to adapt to the vibration generated by the drive motor 4 during operation.

The movement controlling module 8 is inserted on the rear frame body 3-3. As a result, a mounting chamber 14 is enclosed integrally with the limiting plate 11-2 as an end on the rear frame body. The movement controlling module 8 is inserted in the mounting chamber 14. Specifically, the movement controlling module 8 is series-connected with the control board 5 by opening an abutting window 14-1 at a side surface of the mounting chamber 14 corresponding to the control board 5. A communication guide connector 8-1 is exposedly disposed at an end of the movement controlling module 8 corresponding to the control board 5, and a corresponding abutting connector 5-1 is connected on the control board 5 and protrudes through the abutting window 14-1 into the mounting chamber 14. When the movement controlling module 8 is inserted into the mounting chamber 14, the communication guide connector 8-1 and the abutting connector 5-1 are connected. At the same time, a guiding strip convexly and integrally disposed in the mounting chamber 14, and the position of the guiding strip corresponding to an opening of the mounting chamber is shaped like round chamfer, so as to reduce a mounting resistance at the time of assembling the movement controlling module 8 and thus mount the movement controlling module 8 to be in place more smoothly. Furthermore, at least one limiting column 14-2 for winding and bending a power line is disposed integrally on an outer side surface of the mounting chamber 14 corresponding to the switching power source board 13. In this embodiment, three limiting columns 14-2 are arranged along a length direction of the power line. The power line is wound around the three limiting columns 14-2 in sequence in the shape of “S”. An end of the power line is connected to the switching power source board inside the plastic housing and then a movable end of the power line is bent through the limiting columns 14-2 and then passed through a constraint hole of the plastic housing to expose outside the plastic housing and electrically connect with an external power source. The bending of the power line interrupts an external pulling force along a direction of the power line, thus increasing the tensile strength of the power line, and avoiding loosening of a welding point of the power line resulting from directly transmitting the external pulling force to a connection point between the power line and the switching power source board in the device.

Furthermore, the plastic end cover 2 and the plastic housing 1 are specifically connected as follows: a fitting pin 2-1 is convexly disposed at a side of the plastic end cover 2 facing toward the plastic housing 1, a fitting groove 7-3 mated with the fitting pin 2-1 is disposed on the locating portion 7, and the plastic end cover 2 is detachably connected with the locating portion 7 through the fitting pin 2-1 and the fitting groove 7-3. Thus, the plastic end cover 2 is mounted by fitting the fitting pin 2-1 into the fitting groove 7-3 while such fitting structure is concealed in the plastic housing 1, thereby realizing a concise and clean external structure.

The drawer frame 3 and the plastic housing 1 are specifically connected as follows: connection holes 7-2 are disposed along a circumferential direction of the locating portion 7, mounting hole columns 9 mated with the connection holes 7-2 are disposed at an end of the drawer frame 3, and the end of the drawer frame 3 is fixedly connected with the locating portion 7 by inserting screws into the connection holes 7-2 and the mounting hole columns 9. The tightening screws are concealed in the plastic housing 1 to avoid affecting the entire structural aesthetics due to exposure outside the plastic housing 1.

An electric control element 16 is further disposed at an outer side of the mounting chamber 14 corresponding to the control board 5, and the electric control element 16 is in electrical connection with the control board 5. A control valve 17 in connection with the electric control element 16 is disposed at a position of the locating portion 7 corresponding to the electric control element 16. Further, the control valve is exposed on the plastic end cover 2. Further, the opening of the mounting chamber 14 and the connection window 7-1 of the locating portion 7 are correspondingly disposed.

Although detailed descriptions are made to the present invention by referring to the preceding embodiments, those skilled in the art should understand that the technical solutions recorded in the above embodiments may be modified or part of technical features thereof may be equivalently substituted. Any changes, equivalent substitutions and improvements and the like made within the spirit and principle of the present invention shall all fall within the scope of protection of the present invention.

1. A drive device for an electric curtain, wherein it comprises:
an integrally-formed plastic housing, and a plastic end cover is disposed at least one end of the plastic housing, and an outer end face of the plastic end cover is flushed with an end face of the plastic housing or recessed in the plastic housing; and
a drawer frame, and the drawer frame is disposed in the plastic housing, a drive motor and a control board are mounted on the drawer frame, and the drive motor is in electrical connection with the control board.

2. The drive device for an electric curtain of claim 1, wherein an end of the drawer frame is flushed with an end face of the plastic housing to form an end cover, and the other end of the drawer frame is protruded into the plastic housing and fixedly connected with the interior of the plastic housing.

3. The drive device for an electric curtain of claim 2, wherein a locating portion fixedly connected with an end of the drawer frame is integrally formed in the plastic housing, and a connection window is opened on the locating portion.

4. The drive device for an electric curtain of claim 3, wherein a movement controlling module is inserted on the drawer frame, and the movement controlling module is inserted into the connection window and series-connected with the control board.

5. The drive device for an electric curtain of claim 4, wherein connection holes are disposed along a circumferential direction of the locating portion, and mounting hole columns mated with the connection holes are disposed at the end of the drawer frame; the end of the drawer frame is fixedly connected with the locating portion by inserting the screws into the connection holes and the mounting hole columns.

6. The drive device for an electric curtain of claim 5, wherein a fitting pin is convexly disposed at a side of the plastic end cover facing toward the plastic housing, and a fitting groove mated with the fitting pin is disposed on the locating portion; the plastic end cover is detachably connected with the locating portion through the fitting pin and the fitting groove.

7. The drive device for an electric curtain of claim 6, wherein the drawer frame comprises a front frame body, a middle frame body and a rear frame body, and the drive motor is supported on the front frame body; a vibration damping bushing is sleeved on the drive motor; an isolation plate is integrally formed on the middle frame body along a length direction of the entire middle frame body, and the isolation plate is disposed perpendicular to the middle frame body; limiting pieces opposed to the end faces of both sides of the isolation plate are integrally formed on the middle frame body, and the control board is fixed at a side surface of the isolation plate through the limiting piece, and a limiting block is disposed at a side of the isolation plate where the control board is disposed and at an end of the isolation plate close to the front frame body; a switching power source board is disposed at the other side surface of the isolation plate, the switching power source board is fixed on the side surface of the isolation plate through the limiting piece, and limiting plates are disposed integrally and convexly at both ends of the side surface of the isolation plate where the switching power source board is disposed; a mounting chamber is enclosed integrally with the limiting plate as an end on the rear frame body, and the movement controlling module is inserted in the mounting chamber; an abutting window is opened at a side surface of the mounting chamber corresponding to the control board, and the movement controlling module is series-connected with the control board through the abutting window; at least one limiting column for winding and bending a power line is disposed integrally on an outer side surface of the mounting chamber corresponding to the switching power source board.

8. The drive device for an electric curtain of claim 7, wherein limiting sheets are uniformly distributed on inner side surfaces of the front frame body and the middle frame body and isolation strips are uniformly distributed at a side surface of the isolation plate corresponding to the control board; a guiding strip convexly and integrally disposed in the mounting chamber, and the guiding strip corresponding to an opening of the mounting chamber is shaped like round chamfer; an electric control element is further disposed at an outer side of the mounting chamber corresponding to the control board, and the electric control element is in electrical connection with the control board.

9. The drive device for an electric curtain of claim 8, wherein a control valve in connection with the electric control element is disposed at a position of the locating portion corresponding to the electric control element, and the control valve is exposed on the plastic end cover; the opening of the mounting chamber and the connection window of the locating portion are correspondingly disposed.

10. The drive device for an electric curtain of claim 9, wherein a communication guide connector is exposed and disposed at an end of the movement controlling module corresponding to the control board, and a corresponding abutting connector is disposed on the control board and protrudes through the abutting window into the mounting chamber; when the movement controlling module is inserted into the mounting chamber, the communication guide connector and the abutting connector are connected.
